(19) United States
(12) Patent Application Publication
(10) Pub. No.: US 2024/0034505 A1
(43) Pub. Date: Feb. 1, 2024

(54) Apparatus for Producing Perforated Strings of Separable Packages and Blade for Same

(71) Applicant: Frito-Lay North America, Inc., Plano, TX (US)

(72) Inventor: Chad A. Huebner, Hurst, TX (US)

(21) Appl. No.: 17/873,820

(22) Filed: Jul. 26, 2022

(51) Int. Cl. B65B 61/00; B65B 9/12; B26F 1/14

(52) U.S. Cl. CPC B65B 61/007; B65B 9/12; B26F 1/14

(57) ABSTRACT

A vertical form, fill and seal machine includes a pair of reciprocating jaws, located below the product delivery conduit of the machine. The jaws are spaced apart to permit the film tube coming off the product delivery conduit and having a back seal to pass between the jaws after the film tube separates from the product delivery conduit. One of the reciprocating jaws has a toothed blade with a leading edge of the toothed blade extending beyond a leading edge of the one jaw. When the pair of jaws closes, teeth of the blade cut a transversely extending series of perforations adjacent to a transverse seal and cut a transverse opening at an area of the back seal. Accordingly, the machine outputs a continuous string of connected sealed packages having a transversely extending perforation between adjacent packages and having a cut out in the back seal area.

This disclosure relates to vertical form, fill, and seal packaging machines that produce packages having a back seal and being held together in a continuous string with tear lines between the packages for subsequent ease of package separation. Such machines provide a flexible film package string that has a tear line of perforations with a cut-out at the back seal area between the connected packages of the string for ease of subsequent package separation. The disclosure also relates to unique blade configurations that create a desirable tear line of perforations in which a central portion of the tear line of perforations has a gap larger than the perforation gaps.

### BACKGROUND

Vertical form, fill, and seal packaging machines are commonly used in the snack food industry for forming, filling, and sealing bags of chips and other like products. These machines are used to form packages from packaging-film, fill the packages as they are being formed, seal and separate the package by cutting the packaging-film above the seal. These types of machines produce separate filled and sealed packages from package-film.

In some instances, these machines produce a continuous string of separable connected packages with a transversely extending series of perforations adjacent to a transverse seal that may be referred to as a perforation tear line or a tear line of perforations. While such machines are acceptable, continuing development of packaging films has resulted in the formation of packages that, during the process of separating adjacent packages, the perforation tear line propagates normal to the perforation tear line and along the back seal area, which at times undesirably causes the package to open. Solutions to this problem are desired.

The described apparatus and embodiments of the unique blade used in the described apparatus address this problem by providing a cut-out in the back seal area of the transverse seal between adjacent packages.

### SUMMARY

One aspect of the described apparatus relates to a continuous vertical form, fill and seal machine for making a continuous string of separable connected packages. The machine has several features, including a vertically-oriented product delivery conduit; a film dispensing roller configured to mount thereon a roll of package-forming film; a film tensioner oriented and configured to receive, tension and guide package-forming film dispensed from the dispensing roller; and a package-former located and configured to receive tensioned package-film from the film tensioner and guide the package-film around an outer surface of the product delivery conduit. A heat seal bar adjacent the product delivery conduit seals together longitudinal opposed ends of the package-film around the product delivery conduit to create a back seal and to form a film tube as the package-film traverses down the outer surface of the product delivery conduit.

The machine includes a pair of reciprocating jaws located below the product delivery conduit and spaced apart to permit the film tube to pass between the jaws after the film tube separates from the product delivery conduit. One jaw of the reciprocating jaws has a toothed blade and a leading edge of the toothed blade extends beyond a leading edge of the one jaw. When the pair of jaws closes, teeth of the blade cut a transversely extending series of perforations adjacent to a transverse seal and simultaneously cut a transverse opening at an area of the back seal. The opening has a size that is larger than each of the perforation holes. Accordingly, the machine outputs a continuous string of connected sealed packages having a transversely extending perforation between adjacent packages with a cut-out in an area of the back seal. In some instances, the cut-out is a complete cut-out, i.e., a single continuous hole or gap is created at the back seal area.

Another aspect of the disclosure relates to a blade configured for use with the described apparatus in which the apparatus forms a continuous string of separable connected packages having a back seal. In one embodiment, the blade has a front, a back, a first side end, a second side end spaced from the first side end and defining a central portion that is configured to provide a cut-out out in an area of the back seal. The provided opening of the cut-out has a size that is larger than each of the perforation holes. In some instances, the provided cut-out is a complete cut-out, i.e., a single continuous hole or gap is created at the back seal area.

On a top portion of the blade, a first series of perforation teeth extend laterally from the first side end to a first side of the central portion and are spaced from each other; and a second series of perforation teeth extend laterally from the second side end to a second side of the central portion and being spaced from each other.

In one embodiment, each tooth of the first and second series of perforation teeth are formed as wedges along longitudinally opposed sides of the tooth, terminating in a cutting edge along a perimeter of the tooth, and converging in a sharp point. In another embodiment, each tooth of the first and second series of perforation teeth are formed as wedges along laterally opposed sides of the tooth, terminating in a cutting edge along a perimeter of the tooth, and converging in a sharp point.

Another aspect of the disclosure relates to a continuous string of connected sealed packages with each package having a longitudinally extending back seal the packages having a transversely extending perforation between adjacent packages and a cut-out in an area of the back seal. The opening of the cut-out has a size that is larger than each of the perforation holes. In some instances, the cut-out is a complete cut-out, i.e., a single continuous hole or gap is created at the back seal area.

An exemplary method provides a continuous string of separable connected packages from a vertical form, fill and seal machine. The method includes the steps of continuously dispensing packaging-film from a roll of packaging-film, tensioning and guiding the dispensed packaging-film, and enveloping a product delivery conduit with tensioned and guided packaging-film. The method further includes sealing together longitudinal opposed ends of the package-film to create a back seal and to form a film tube, moving the film tube down and feeding product into the film tube from the product delivery conduit. The film tube is sealed with a pair of transverse seals, which have a transverse tear line comprising perforations located between them and which have a cut-out in an area of the back seal. The opening of the cut-out has a size that is larger than each of the perforation holes. In some instances, the cut-out is a complete cut-out, i.e., a single continuous hole or gap is created at the back seal area.

Continuous operation of the vertical form, fill and seal machine in this manner provides a continuous string of connected sealed packages having a transversely extending perforation between adjacent packages with a cut-out in an area of the back seal. When required or desired, the string of packages can then be separated into individual packages with ease along the tear lines such that propagation of the perforation tear line in a direction normal to the transverse tear line is minimized.

As used in this description, the phrases, “back seal area” and “area of the back seal” refers to at least the lateral extent of the back seal, whether it is a lap seal or fin seal and is meant to include the area immediately adjacent to each lateral side of the back seal. In other words, the “back seal area” and “area of the back seal” encompasses the back seal as well as a small portion of the transverse seal laterally adjacent each side of the back seal.

Other aspects and advantages of this invention will be appreciated from the following detailed description.

The foregoing aspects and many of the attendant advantages of the present technology will become more readily appreciated by reference to the following Detailed Description, when taken in conjunction with the accompanying simplified drawings of exemplary embodiments. The illustrative, schematic drawings, briefly described here below, are not to scale, are presented for ease of explanation and do not limit the scope of the inventions recited in the accompanying patent claims.

### BRIEF DESCRIPTION OF DRAWINGS

FIG. 1 is a schematic of a vertical form, fill and seal apparatus, in accordance with an exemplary embodiment.

FIG. 2 is one embodiment of a separated package having a back seal in the form of a fin seal.

FIG. 3 is another embodiment of a separated package having a back seal in the form of a lap seal.

FIG. 4 illustrates a string of connected filled packages produced from a vertical form, fill and seal apparatus in accordance with an exemplary embodiment and illustrating the transverse tear line comprising perforations with a cut-out in the back seal area.

FIG. 5 illustrates an exemplary embodiment of a pair of jaws that include a knife or toothed blade located between a pair of heat sealing elements.

FIG. 6 is a perspective view of an exemplary embodiment of a knife or toothed blade.

FIG. 7 is a front view of the exemplary embodiment of the knife of toothed blade shown in FIG. 6.

FIG. 7A is a cross-sectional view taken along line 7A-7A in FIG. 7.

FIG. 8 is a perspective view of another exemplary embodiment of a knife or toothed blade.

FIG. 9 is a front view of the exemplary embodiment of the knife of toothed blade shown in FIG. 8.

FIG. 9A is an enlarged view of perforation teeth of FIG. 9, as indicated on the drawing.

FIG. 9B is an enlarged view of cutting teeth of FIG. 9, as indicated on the drawing.

### DETAILED DESCRIPTION

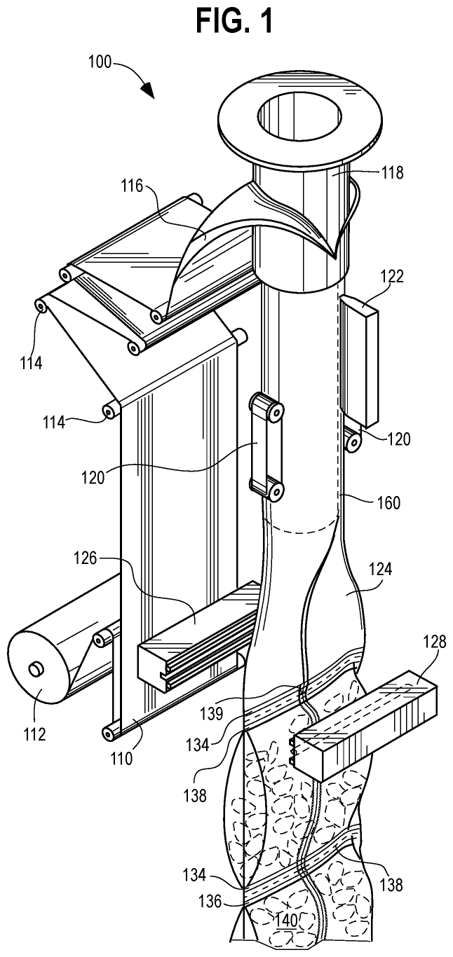

Turning to FIG. 1, an exemplary vertical form, fill, seal packaging machine is shown. This drawing is simplified and does not show the cabinet and support structures that typically surround a machine 100. Packaging-film 110 is unwound from a roll 112 of film and passed through tensioners 114 that keep it taut. Packaging-film is typically polypropylene, polyester, paper, polyolefin extrusions, adhesive laminates, and other such materials including, but not limited to, polyhydroxyalkanoate (PHA), polylactide (PLA), polybutylene adipate terephthalate (PBAT), and polybutyl succinate (PBS), or layered combinations of these film materials. For many food products, where flavor retention is important, a metalized or barrier layer may be used to form the inner-most layer.

The packaging-film 110 passes from the tensioners 114 over a former 116, which directs the packaging-film into a vertical tube around a product delivery conduit 118. As the tube is pulled downward by drive belts 120, the vertical tube of film is sealed along its length by a vertical sealer 122, to form a film tube 124 having a continuous longitudinally extending back seal 160.

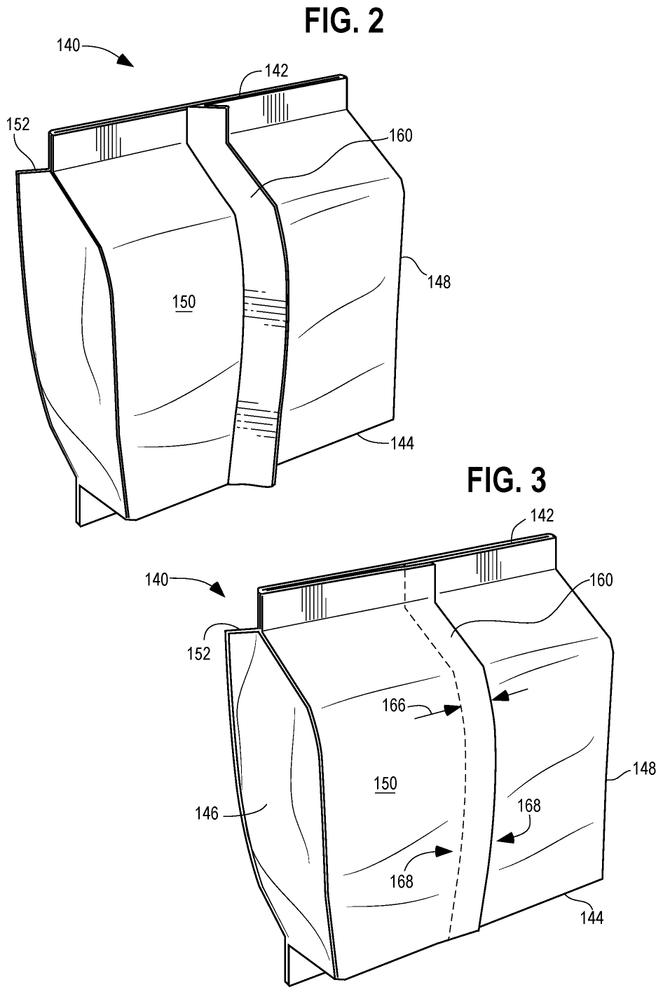

The machine applies the pair of heat sealing jaws 126, 128 against the film tube 133 to form a pair of transverse seals 134, 136. One of the pair of transverse seals acts as the top seal 134 of a package 140 created by that cycle, and the other part of the transverse seal acts as the bottom seal 136 of the next package 140 that will be made in the machine. One of the heat seal jaws includes a blade 200 that creates a transverse perforation tear line 138 between the top seal 134 and bottom seal 136 of each adjacent package 140 for ease of subsequent separation of the string into individual packages 140, as illustrated in FIGS. 2-4, for example.

Turning to FIGS. 2 and 3, two different embodiments of individual packages 140 are shown. Each package has a top 142, bottom 144, first side 146, second side 148, a back 150 with a back seal 160, and a front 152 opposite the back. The top and bottom of each package is sealed by the transverse seal. Typically, the back seal 160 extends longitudinally from the top to the bottom of the package and is located at about the mid-point between the first and second side of the package, i.e., centrally located.

FIG. 2 illustrates a fin seal and FIG. 3 illustrates a lap seal, both of which are known to the skilled artisan. It will be appreciated that the back seal 160, whether it is a fin seal or a lap seal has a first edge 162 and a second edge 164, with the distance between the first and second edge 162, 164 defining the lateral distance 166 of back seal 160. In this regard, back seal defines a back seal area also referred to as an area of the back seal 168, both of which refer to at least the lateral distance of the back seal and is meant to include the area immediately adjacent to each of the first and second edge of the back seal. In other words, the back seal area and area of the back seal encompasses the back seal as well as a small portion of the transverse seal laterally adjacent each edge of the back seal extending away from the back seal and towards the respective first and second side 146, 148 of the package.

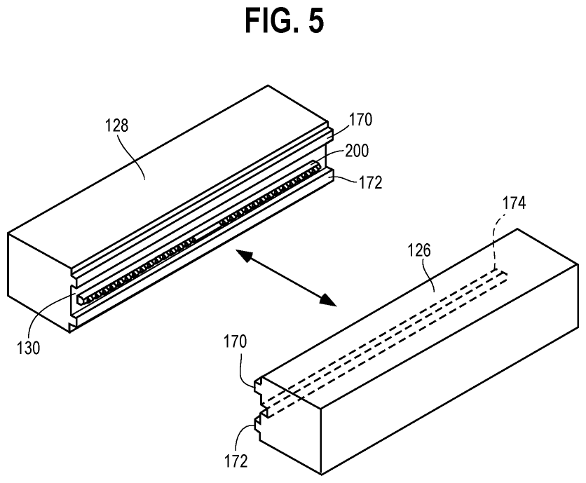

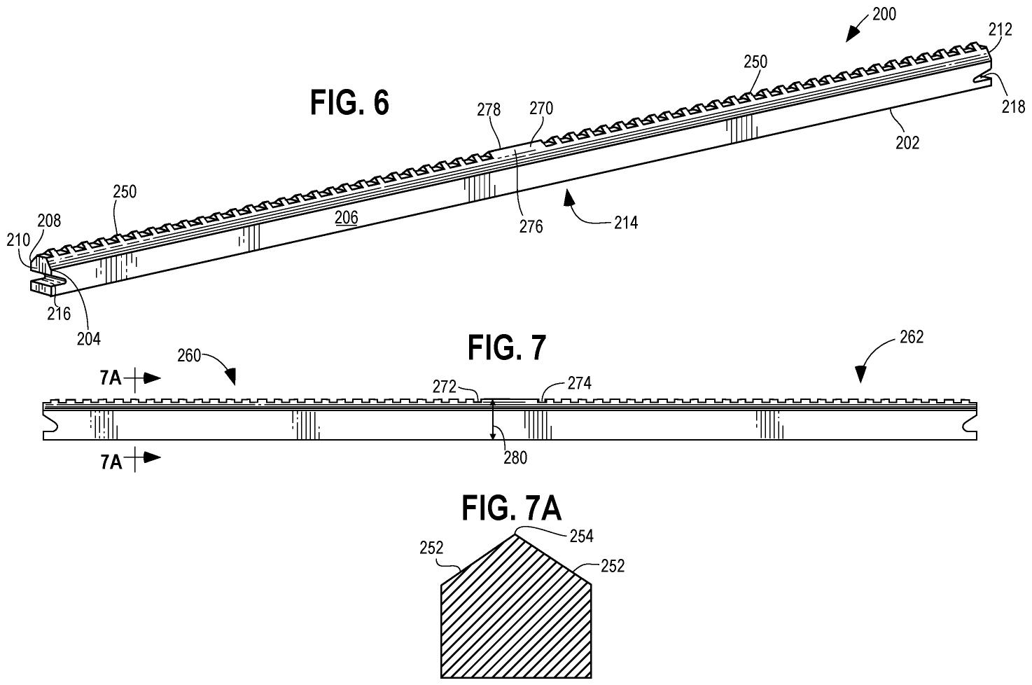

Referring to FIG. 5, an exemplary embodiment of heat sealing and perforating jaws shows a pair of jaws 126, 128 that include a blade 200, which in this instance is a toothed blade and is located between the two heating surfaces 170, 172, of one jaw. The toothed blade 150 may be held fixedly but releasably in position mounted to the jaw. Thus, a shank portion of each tooth projects out from the body of the blade 200 and terminates in a head that forms part of a leading edge of the blade. The leading edge projects beyond the leading end 130 of the jaw such that the teeth 250, 270 of the blade 200 (seen more clearly in FIGS. 6-9) can be urged against a package-film adjacent the transverse seal 134 with sufficient force during closing of the jaws 126, 128 to perforate the package-film and thereby form a perforation tear line 138 comprised of spaced perforations caused by, and corresponding to, the spaced apart teeth 250. Simultaneously, because of the advantageous structure of the described blade 200, particularly, the presence of a single tooth 270, a cut-out 139 in the area of the back seal 168 is created. During jaw closing, the teeth 250, 270 may project into a slot 174 in the opposing jaw after penetrating the packaging-film to avoid inadvertent blunting or other damage to the sharp pointed tips 254, 278 of the teeth 250, 270, respectively.

Referring now to FIGS. 6 and 7, one embodiment of a blade 200 is shown. The blade has a base 202, top 204, front 206, back 208, first side end 210, second side end 212 spaced from the first side end to define a central portion 214 of the blade at about the midpoint between the first side end 210 and the second side end 212. A line beginning at the first side end 210 and ending at the second side end 212 defines a longitudinal direction of the blade 200. When mounted, the top 204 of the blade 200 may be adjacent the leading end 130 of the jaw so that the teeth 250 extend beyond the leading end 130 and the first 170 and second 172 heating surfaces of the jaw. The blade 200 may be mounted in a fixed position in a recess in the jaw 128, for example, using the exemplary locating and positioning features 216, 218. Thus, the blade 200 moves in unison with jaw 128.

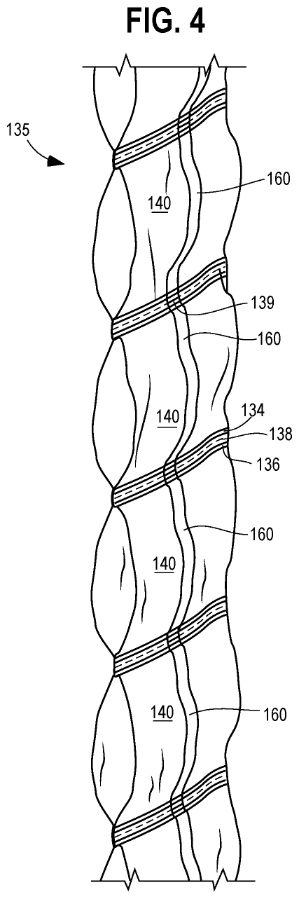

In this embodiment, the central portion 214 is provided with a single tooth 270 that extends longitudinally a defined length such that a first side of the central portion 272 and a second side of the central portion 274 are defined. The defined length is approximately the same as the width of the back area seal 168 so that, in operation, a cut-out 139 may be effected at the back seal area. It will be appreciated that because the central portion has only a single tooth 270, a complete cut-out 139 will be formed. As can be appreciated by viewing FIG. 4, the term “complete cut-out” means that a single continuous hole or gap is created at the back seal area 168. In other words, the gap or hole in the back seal area is larger than each of the perforation gaps or holes. The single tooth 270 includes a wedge 276 along longitudinally opposed sides of the tooth 270 that terminates in a cutting edge along a perimeter of the tooth and converges in a sharp point 278. The sharp point 278 of the single tooth 270 extends from the blade 200 a defined distance 280 from a base 202 of the blade.

A first series 260 of spaced perforation teeth 250 extend from the first side end 210 to a first side of the central portion 272. A second series 262 of spaced perforation teeth 250 extend from the second side end 212 to a second side of the central portion 274. While the perforation teeth 250 are shown as being spaced apart equidistantly, such even spacing, while perhaps aesthetically desirable, is not essential for producing tear lines 138 to separate a continuous string of separable packages.

Referring to FIG. 7A, the head portion of each tooth of the first and second series 260, 262 of perforation teeth 250 include wedges 252 along longitudinally opposed sides of the tooth that terminate in a cutting edge along a perimeter of the tooth and converge in a sharp point 254. The wedges 252 extend along the opposed sides of the tooth and the wedges from the opposing sides converge in a sharp pointed tip 254 of each tooth that is able to penetrate packaging-film during normal operation of the vertical form, fill and seal machine. Moreover, the teeth 250 of illustrated blade of FIGS. 6 and 7 are symmetrical about an axis extending through the tip 254.

The sharp point of each perforation tooth 250 extends from the blade a defined distance 256 from a base 202 of the blade 200 and in some instances, the defined distance is the same for each perforation tooth 250. In some instances the defined distance 256 of each perforation tooth 250 is the same as the defined distance 280 for the sharp point 278 of the single tooth 270.

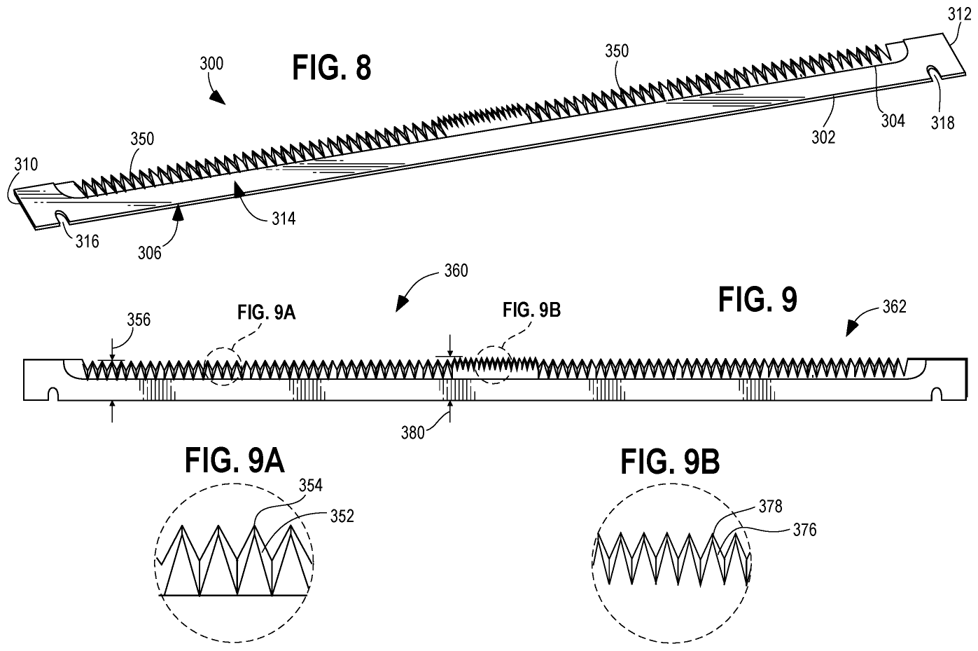

Referring now to FIGS. 8 and 9, another embodiment of a blade 300 is shown. The blade 300 has a base 302, top 304, front 306, back 308, first side end 310, second side end 312 spaced from the first side end 310 to define a central portion 314 of the blade 300 at about the midpoint between the first side end 310 and the second side end 312. The blade 300 may be mounted in a fixed position in a recess in the jaw 128, for example, using the exemplary locating and positioning features 316, 318. Thus, the blade moves in unison with jaw 128. When mounted, the top 304 of the blade 300 may be adjacent the leading end 130 of the jaw so that the teeth 350, 370 extend beyond the leading end 130 and the first 170 and second 172 heating surfaces of the jaw.

A first series 360 of spaced perforation teeth 350 extend from the first side 310 end to a first side of the central portion 372. A second series 362 of spaced perforation teeth 350 extend from the second side end 312 to a second side of the central portion 374. While the perforation teeth 350 are shown as being spaced apart equidistantly, such even spacing, while perhaps aesthetically desirable, is not essential for producing a perforation tear line 138 used to separate a continuous string of separable packages.

Referring to FIG. 9A, the head portion of each perforation tooth 350 of the first and second series 360, 362 include wedges 352 along laterally opposed sides of the tooth 350 that terminate in a cutting edge along a perimeter of the tooth and converge in a sharp point 354. The wedges 352 extend along the opposed sides of the tooth and the wedges 352 from the opposing sides converge in a sharp pointed tip 354 of each tooth 350 that is able to penetrate packaging-film during normal operation of the vertical form, fill and seal machine. Moreover, in this embodiment, the teeth 350 are symmetrical about an axis extending through the tip of the sharp point 354. The sharp point 354 of each perforation tooth 350 extends from the blade a defined distance 356 from the base of the blade 302 and in some instances, the defined distance is the same for each perforation tooth 350.

In this embodiment, the central portion 314 of the blade 300 is provided with a series of spaced cutting teeth 370 that extend longitudinally a defined length such that a first side of the central portion 372 and a second side of the central portion 374 are defined. The defined length is approximately the same as the width of the back area seal 168 so that, in operation, a cut-out 139 may be effected at the back seal area 168.

As best seen in FIG. 9B, the cutting teeth 370 are shown as being spaced apart equidistantly. Such even spacing, while perhaps aesthetically desirable, is not essential for producing the cut-out 139 in the continuous string of separable packages. It will also be appreciated that the spacing between the cutting teeth 370 is less than the spacing between the teeth 350 in each of the first 360 and second series 362 of perforation teeth 350. Because the spacing between the cutting teeth 370 is smaller than the spacing between the perforation teeth 350, it will be appreciated that the cutting teeth 370 will create a cut-out 139 in the area of the back seal 168. In some instances, the gap or hole in the back seal area 168 is larger than each of the perforation gaps or holes. In other embodiments, the cut-out 139 defines a single continuous hole or gap at the back seal area 168 such that the cut-out 139 is a complete cut-out 139.

The head portion of each cutting tooth 370 includes wedges 376 along laterally opposed sides of the tooth 370 that terminate in a cutting edge along a perimeter of the tooth and converge in a sharp point 378. The wedges 376 extend along the opposed sides of the tooth and the wedges from the opposing sides converge in a sharp pointed tip 378 of each tooth that is able to penetrate the back seal 160 during normal operation of the vertical form, fill and seal machine. Moreover, in this embodiment, the teeth 370 are symmetrical about an axis extending through the sharp point or tip 378.

The sharp point 378 of each cutting tooth 370 extends from the blade a defined distance 380 from a base 302 of the blade and in some instances, the defined distance 380 is the same for each cutting tooth 370. In addition, as best seen in FIG. 9, the defined distance 380 of the cutting teeth 370 is greater than the defined distance 356 for each of the first and second series 360, 362 of perforation teeth 350 so that the cutting teeth 370 are able to penetrate the back seal area 160 to form the cut-out 139.

During an exemplary operation, packaging-film is unwound from a film-dispensing roll 112 of the machine 100. The packing-film is tensioned and guided to a former 116 which guides the packaging-film over a product delivery conduit 118. As the packaging-film, shaped around the product delivery conduit travels along the length of the conduit, opposed ends of the packaging-film are sealed together to form a film tube 124 having a continuous longitudinal back seal 160. Product is delivered to the back-sealed lower region of the tube film 124. The film tube 124 is then sealed with a pair of reciprocating jaws that include a toothed blade 200, 300 located between a pair of heat sealing elements 142, 144. This forms a pair of parallel transverse seals 134, 136 with a tear line 138 comprised of perforations formed by the toothed blade between the seals. Simultaneously, a cut-out 139 in the back seal area 168 is also created. The cut-out 139 has a gap that is larger than each gap of the perforation holes or gaps. In some instances, the cut-out 139 is a complete cut-out 139, as described above. Continuous operation produces a string 135 of connected packages 140, as illustrated for example in FIG. 4, which can be later separated along the perforation tear line 138 (and cut-out 139).

From the foregoing, an exemplary method provides a continuous string of separable connected packages from a vertical form, fill and seal machine. The method includes the steps of continuously dispensing packaging-film from a roll of packaging film, tensioning and guiding the dispensed packaging-film, and enveloping a product delivery conduit with tensioned and guided packaging-film. The method further includes sealing together longitudinal opposed ends of the package-film to form a film tube, moving the film tube down and feeding product into the film tube from the product delivery conduit. The film tube is sealed by using opposed reciprocating jaws to create a pair of transverse seals, which have a transverse tear line comprising perforations located between them. Continuous operation of the vertical form, fill and seal machine in this manner provides a continuous string of connected sealed packages having a transversely extending perforation between adjacent packages. When required or desired, the string of packages can then be separated into individual packages with ease along the tear lines.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. A continuous vertical form, fill and seal machine for making a continuous string of separable connected packages, the machine comprising:
a vertically-oriented product delivery conduit;
a film dispensing roller configured to mount thereon a roll of package-forming film;
a film tensioner oriented and configured to receive, tension and guide package-forming film dispensed from the dispensing roller;
a package-former located and configured to receive tensioned package-film from the film tensioner and guide the package-film around an outer surface of the product delivery conduit;
a heat seal bar adjacent the product delivery conduit to seal together longitudinal opposed ends of the package-film to create a back seal and to form a film tube as the package-film traverses down the outer surface of the product delivery conduit; and
a pair of reciprocating jaws located below the product delivery conduit and spaced apart to permit the film tube to pass between the jaws after the film tube separates from the product delivery conduit, one jaw of the reciprocating jaws having a toothed blade, a leading edge of the toothed blade extending beyond a leading edge of the one jaw;
wherein, when the pair of jaws closes, teeth of the blade cut a transversely extending series of perforations adjacent to a transverse seal and cut a transverse opening at an area of the back seal to form a continuous string of connected sealed packages having a transversely extending perforation between adjacent packages with a cut-out in an area of the back seal.

2. The machine of claim 1, wherein the toothed blade extends between a pair of sealing surfaces of one of the reciprocating jaws.

3. The machine of claim 1, wherein the toothed blade comprises
a front, a back, a first side end, a second side end spaced from the first side end and defining a central portion that is configured to provide a cut-out out in the area of the back seal;
a first series of perforation teeth extending from the first side end to a first side of the central portion and being spaced from each other; and,
a second series of perforation teeth extending from the second side end to a second side of the central portion and being spaced from each other;

4. The machine of claim 3, wherein the first series of perforation teeth are spaced equidistant from each other and the second series of perforation teeth are spaced equidistant from each other.

5. The machine of claim 4, wherein each tooth of the first and second series of perforation teeth comprises wedges along longitudinally opposed sides of the tooth, terminating in a cutting edge along a perimeter of the tooth, and converging in a sharp point.

6. The machine of claim 5, wherein the sharp point of each tooth extends from the blade a defined distance from a base of the blade.

7. The machine of claim 6, wherein the defined distance is the same for each tooth.

8. The machine of claim 3 wherein the central portion includes a single tooth extending longitudinally from the first side of the central portion to the second side of the central portion.

9. The machine of claim 8 wherein the single tooth comprises a wedge along longitudinally opposed sides of the single tooth, terminating in a cutting edge along a perimeter of the single tooth, and converging in a sharp point.

10. The machine of claim 3, wherein each tooth of the first and second series of perforation teeth comprises wedges along laterally opposed sides of the tooth, terminating in a cutting edge along a perimeter of the tooth, and converging in a sharp point.

11. The machine of claim 10, wherein the first series of perforation teeth are spaced equidistant from each other and the second series of perforation teeth are spaced equidistant from each other.

12. The machine of claim 10, wherein the sharp point of each tooth extends from the blade a defined distance from a base of the blade.

13. The machine of claim 12, wherein the defined distance is the same for each tooth.

14. The machine of claim 10, wherein the central portion includes a series of cutting teeth extending longitudinally from the first side of the central portion to the second side of the central portion.

15. The machine of claim 14, wherein each cutting tooth comprises wedges along laterally opposed sides of the tooth, terminating in a cutting edge along a perimeter of the tooth, and converging in a sharp point.

16. The machine of claim 14 wherein each cutting tooth is spaced equidistant from each other.

17. The machine of claim 15 wherein the sharp point of each cutting tooth extends from the blade a defined distance from a base of the blade.

18. The machine of claim 17, wherein the defined distance is the same for each cutting tooth.

19. The machine of claim 18, wherein the defined distance for the cutting teeth is greater than the defined distance of the perforation teeth.

20. A perforation blade configured for use with a continuous vertical form, fill and seal machine for making a continuous string of separable connected packages having a back seal, the blade comprising:
a front, a back, a first side end, a second side end spaced from the first side end and defining a central portion that is configured to provide a cut-out in an area of the back seal;
a first series of perforation teeth extending from the first side end to a first side of the central portion and being spaced from each other; and,
a second series of perforation teeth extending from the second side end to a second side of the central portion and being spaced from each other;
wherein each tooth of the first and second series of perforation teeth comprises a wedge having a first side and a second side terminating at a tip and wherein the first side of each tooth lies on one side of a line traversing each tip that defines a longitudinal direction of the blade.

21. The perforation blade of claim 20 wherein the first series of perforation teeth are spaced equidistant from each other and the second series of perforation teeth are spaced equidistant from each other.

22. (canceled)

23. The perforation blade of claim 20, wherein the lip of each tooth extends from the blade a defined distance from a base of the blade.

24. The perforation blade of claim 23, wherein the defined distance is the same for each tooth.

25. The perforation blade of claim 20 wherein the central portion includes a single tooth extending longitudinally from the first side of the central portion to the second side of the central portion.

26. The perforation blade of claim 25 wherein the single tooth comprises a wedge having a first side and a second side, each terminating in a cutting edge tip, wherein the first side lies on one side of the longitudinal direction of the blade.

27. The perforation blade of claim 20, wherein each tooth of the first and second series of perforation teeth comprises wedges along laterally opposed sides of the tooth, terminating in a cutting edge along a perimeter of the tooth, and converging in a sharp point.

28. The perforation blade of claim 27, wherein the first series of perforation teeth are spaced equidistant from each other and the second series of perforation teeth are spaced equidistant from each other.

29. The perforation blade of claim 27, wherein the sharp point of each tooth extends from the blade a defined distance from a base of the blade.

30. The perforation blade of claim 29, wherein the defined distance is the same for each tooth.

31. The perforation blade of claim 27, wherein the central portion includes a series of cutting teeth extending longitudinally from the first side of the central portion to the second side of the central portion.

32. The perforation blade of claim 31, wherein each cutting tooth comprises wedges along laterally opposed sides of the tooth, terminating in a cutting edge along a perimeter of the tooth, and converging in a sharp point.

33. The perforation blade of claim 31 wherein each cutting tooth is spaced equidistant from each other.

34. The perforation blade of claim 32 wherein the sharp point of each cutting tooth extends from the blade a defined distance from a base of the blade.

35. The perforation blade of claim 34, wherein the defined distance is the same for each cutting tooth.

36. The perforation blade of claim 35, wherein the defined distance for the cutting teeth is greater than the defined distance of the perforation teeth.

37. A continuous string of connected sealed packages with each package having a longitudinally extending back seal, the packages having a transversely extending perforations between adjacent packages and a cut-out in an area of the back seal, wherein the cut-out defines a gap having a transverse length greater than a gap of each in the transversely extending perforations.

38. A method of making a continuous string of separable connected packages on a vertical form, fill and seal machine, the method comprising:
continuously dispensing packaging-film from a roll of packaging film;
tensioning and guiding the dispensed packaging-film;
enveloping a product delivery conduit with tensioned and guided packaging-film;
sealing together longitudinal opposed ends of the package-film to create a back seal and to form a film tube;
moving the film tube down and feeding product into the film tube from the product delivery conduit; and
sealing and the film tube with a pair of transverse seals having a transverse tear line comprising perforations located between the transverse seals;
whereby continuous operation of the vertical form, fill and seal machine provides a continuous string of connected sealed packages having a transversely extending perforation between adjacent packages with a cut-out in an area of the back seal.

39. The method of claim 38, wherein the step of sealing comprises reciprocating a pair of jaws comprising a pair of heat sealing elements and a toothed blade to seal the film tube by forming a pair of spaced apart transverse seals and substantially simultaneously creating a perforated tear line between the transverse seals with the teeth of the blade and a cut-out in an area of the back seal.
